(19) United States
(12) Patent Application Publication
(10) Pub. No.: US 2024/0329222 A1
(43) Pub. Date: Oct. 3, 2024

(54) FACILITY INSPECTION DISPLAY DEVICE, INFORMATION PROCESSING DEVICE, AND NON-TRANSITORY COMPUTER-READABLE MEDIUM

(71) Applicant: NEC Corporation, Minato-ku, Tokyo (JP)

(72) Inventor: Ryusuke IMAI, Tokyo (JP)

(73) Assignee: NEC Corporation, Minato-ku, Tokyo (JP)

(21) Appl. No.: 18/698,397

(22) PCT Filed: Oct. 20, 2021
(86) PCT No.: PCT/JP2021/038709

§ 371 Date: Apr. 4, 2024

(51) Int. Cl. G01S 7/51; G01S 17/58; G01S 17/89

(52) U.S. Cl. CPC G01S 7/51; G01S 17/58; G01S 17/89

(57) ABSTRACT

A facility inspection display device includes: a trajectory display unit that displays a trajectory of coordinates serving as a base point when point cloud data of a facility using LiDAR is acquired by moving the LiDAR in the facility; a point cloud data display unit that displays the point cloud data acquired with user-designated coordinates at a user-designated position on the trajectory designated by a user in the trajectory display unit as the base point; and a deterioration event display unit that causes the trajectory display unit to display, as a deterioration event position, deterioration event coordinates serving as the base point when the point cloud data including a deterioration event of the facility is acquired.

### TECHNICAL FIELD

The present invention relates to a facility inspection display device, an information processing device, a facility inspection display method, and a non-transitory computer-readable medium.

### BACKGROUND ART

For the purpose of inspecting a water conduit in a hydraulic power plant, a technique using a moving object such as a robot or a drone is known. In addition, a deterioration event inspection solution for detecting a crack or the like generated in a water conduit from point cloud data acquired by light detection and ranging (LiDAR) has also been studied.

In a case where the granularity of the point cloud data acquired by LiDAR is coarse, it is difficult to determine the size and type of the deterioration event, and thus it is necessary to use confirmation by image data such as a moving image or a still image captured by a camera. However, in the case of capturing a moving image, a large-capacity battery or storage is required in a water conduit in which a long-time inspection is assumed. Therefore, the weight and size of equipment increase, and it is difficult to carry the equipment into the water conduit.

Patent Literature 1 describes inspecting a facility using point cloud data and image data.

### CITATION LIST

### Patent Literature

Patent Literature 1: Japanese Unexamined Patent Application Publication No. 2021-015572

### SUMMARY OF INVENTION

### Technical Problem

In the display method of Patent Literature 1, it is difficult to perform position synchronization between the point cloud data and the image data (still image). In particular, it is difficult to associate the coordinates of the deterioration event included in the point cloud data with the image data.

There is a LiDAR equipped with a device that detects three-dimensional inertial motion called an inertial measurement unit (IMU), and in this case, position information (trajectory data) at the time of point cloud data acquisition can be recorded in time series. Using the IMU, it is desired to perform position synchronization between point cloud data and image data (still image), associate a deterioration event with image data corresponding to the deterioration event, and improve visibility of the deterioration event.

In addition, in a case where the location of the deterioration event is specified based on visual observation or past inspection results, there is a possibility that the image data corresponding to the deterioration event may be omitted. It is desired to display the coordinates of the deterioration event in which the image data leakage has occurred to improve the visibility of the deterioration event.

An object of the present disclosure is to solve such a problem, and to provide a facility inspection display device, an information processing device, a facility inspection display method, and a non-transitory computer-readable medium capable of improving visibility in display of a position of a deterioration event.

### Solution to Problem

A facility inspection display device according to the present disclosure includes: a trajectory display means for displaying a trajectory of coordinates serving as a base point when point cloud data of a facility using LiDAR is acquired by moving the LiDAR in the facility; a point cloud data display means for displaying the point cloud data acquired with user-designated coordinates at a user-designated position on the trajectory designated by a user in the trajectory display means as the base point; and a deterioration event display means for causing the trajectory display means to display, as a deterioration event position, deterioration event coordinates serving as the base point when the point cloud data including a deterioration event of the facility is acquired.

In addition, an information processing device according to the present disclosure includes: a trajectory information holding means for holding trajectory information including a trajectory of coordinates serving as a base point when point cloud data of a facility using LiDAR is acquired by moving the LiDAR in the facility, each coordinate of a plurality of base points constituting the trajectory, and each time at which the LiDAR has passed through each coordinate; a point cloud data information holding means for holding point cloud data information including each point cloud data acquired with each coordinate as the base point and each time at which the LiDAR has passed through each coordinate serving as the base point when each point cloud data is acquired; and a deterioration event coordinate extraction means for extracting deterioration event coordinates serving as the base point when the point cloud data including a deterioration event of the facility is acquired from the trajectory information and the point cloud data information.

Furthermore, a facility inspection display method according to the present disclosure includes: a step of causing a trajectory display means to display a trajectory of coordinates serving as a base point when point cloud data of a facility using LiDAR is acquired by moving the LiDAR in the facility; a step of causing a point cloud data display means to display the point cloud data acquired with user-designated coordinates at a user-designated position on the trajectory designated by a user in the trajectory display means as the base point; and a step of causing the trajectory display means to display, as a deterioration event position, deterioration event coordinates serving as the base point when the point cloud data including the deterioration event of the facility is acquired.

In addition, a facility inspection display program according to the present disclosure causes a computer to execute: a step of causing a trajectory display means to display a trajectory of coordinates serving as a base point when point cloud data of a facility using LiDAR is acquired by moving the LiDAR in the facility; a step of causing a point cloud data display means to display the point cloud data acquired with user-designated coordinates at a user-designated position on the trajectory designated by a user in the trajectory display means as the base point; and a step of causing the trajectory display means to display, as a deterioration event position, deterioration event coordinates serving as the base point when the point cloud data including the deterioration event of the facility is acquired.

### Advantageous Effects of Invention

According to the present disclosure, it is possible to provide a facility inspection display device, an information processing device, a facility inspection display method, and a non-transitory computer-readable medium capable of improving visibility in display of a position of a deterioration event.

### BRIEF DESCRIPTION OF DRAWINGS

FIG. 1 is a configuration diagram illustrating a facility inspection system according to a first example embodiment.

FIG. 2 is a block diagram illustrating an information processing device according to the first example embodiment.

FIG. 3 is a plan view illustrating a display screen of the facility inspection display device according to the first example embodiment.

FIG. 4 is a flowchart illustrating a facility inspection method according to the first example embodiment.

FIG. 5 is a flowchart illustrating the facility inspection display method according to the first example embodiment.

FIG. 6 is a plan view illustrating a display screen of a facility inspection display device according to a second example embodiment.

FIG. 7 is a flowchart illustrating a facility inspection display method according to the second example embodiment.

FIG. 8 is a block diagram illustrating an information processing device according to the second example embodiment.

### EXAMPLE EMBODIMENT

Hereinafter, example embodiments will be described with reference to the drawings. For clarity of description, in the following description and figures, omission and simplification are made as appropriate. Further, in each drawing, the same elements are denoted by the same reference signs, and redundant description is omitted as necessary.

### First Example Embodiment

A facility inspection system according to a first example embodiment will be described. The facility inspection system according to the present example embodiment inspects a facility using point cloud data of the facility and image data of the facility. The facility is, for example, a water conduit in a hydraulic power plant, but is not limited thereto, and the facility is not limited to a substation of a power plant, a tunnel of a road, or the like as long as the point cloud data and the image data can be acquired.

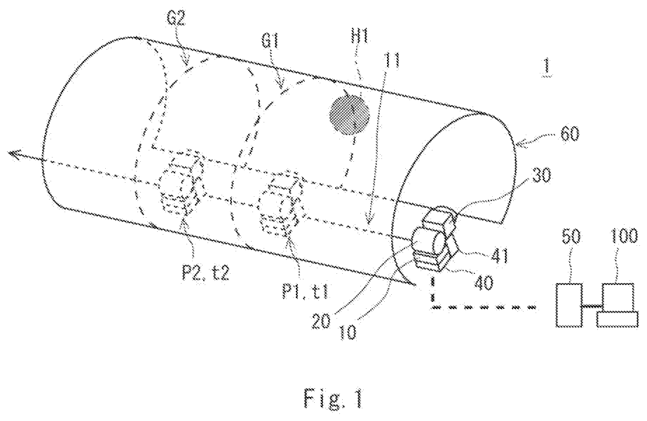

FIG. 1 is a configuration diagram illustrating the facility inspection system according to the first example embodiment. As illustrated in FIG. 1, the facility inspection system 1 includes an inertial motion detection device 10, a point cloud data acquisition device 20, an image data acquisition device 30, a moving object 40, a moving object 41, an information processing device 50, and a facility inspection display device 100. Each of the inertial motion detection device 10, the point cloud data acquisition device 20, the image data acquisition device 30, the moving object 40, the moving object 41, the information processing device 50, and the facility inspection display device 100 has a function as an inertial motion detection means, a point cloud data acquisition means, an image data acquisition means, a movement means, a movement means, an information processing means, and a facility inspection display means. Each configuration will be described below.

### <Inertial Motion Detection Device>

The inertial motion detection device 10 detects an inertial motion. The inertial motion detection device 10 is, for example, an IMU. Note that the inertial motion detection device 10 is not limited to the IMU as long as it is a device that detects inertial motion, and may be a device that detects inertial motion that a person skilled in the art would conceive. Hereinafter, an IMU will be described as an example of the inertial motion detection device 10.

The IMU is mounted on the moving object 40 together with the point cloud data acquisition device 20. The IMU acquires a trajectory 11 of the moving object 40 moving in the facility 60. Since the point cloud data acquisition device 20 is also mounted on the moving object 40, the IMU acquires the trajectory 11 of coordinates serving as a base point when the point cloud data of the facility 60 is acquired. In addition, the IMU acquires each coordinate of a plurality of base points constituting the trajectory 11. Further, the IMU acquires the time at which it has passed through each coordinate of the plurality of base points constituting the trajectory 11 using the timer.

The coordinates constituting the trajectory 11 continue continuously along the trajectory 11, and for example, as illustrated in FIG. 1, the coordinates P1 and the coordinates P2 will be described as an example. The coordinates P1 and P2 constituting the trajectory 11 are associated with the times t1 and t2 at which the IMU has passed through the coordinates P1 and P2, respectively.

The trajectory 11 acquired by the IMU, each coordinate constituting the trajectory 11, and each time at which the IMU has passed through each coordinate are referred to as trajectory information. That is, the trajectory information includes the trajectory 11 of coordinates serving as a base point when the point cloud data of the facility 60 is acquired, each coordinate of a plurality of base points constituting the trajectory 11, and each time at which the IMU has passed through each coordinate.

The IMU outputs the acquired trajectory information to the information processing device 50. The IMU may output the trajectory information to the information processing device 50 via a wireless or wired communication line, or may output the trajectory information to the information processing device 50 via a storage medium.

### <Point Cloud Data Acquisition Device>

The point cloud data acquisition device 20 acquires point cloud data. The point cloud data acquisition device 20 is, for example, LiDAR. Note that the point cloud data acquisition device 20 is not limited to the LiDAR as long as it is a device that acquires point cloud data, and may be a device that acquires point cloud data that a person skilled in the art would conceive. Hereinafter, LiDAR will be described as an example of the point cloud data acquisition device 20.

The LiDAR is mounted on the moving object 40 together with the IMU. The LiDAR acquires point cloud data of the facility 60. Specifically, the LiDAR moves the coordinates serving as the base point using the moving object 40 while acquiring the point cloud data of the facility 60 from the coordinates serving as the base point. Therefore, the coordinates serving as the base point when the point cloud data of the facility 60 is acquired form the trajectory 11. This trajectory 11 is obtained by the IMU. The LiDAR acquires each point cloud data with each coordinate included in the trajectory 11 as a base point. In addition, the LiDAR acquires each time at which the LiDAR has passed through each coordinate. Then, each coordinate constituting the trajectory 11 is associated with each time at which the LiDAR has passed through each coordinate. In addition, each point cloud data acquired with each coordinate constituting the trajectory 11 as a base point is associated with each time at which the LiDAR has passed through each coordinate.

For example, as illustrated in FIG. 1, the coordinates P1 and P2 will be described as an example. The coordinates P1 and P2 constituting the trajectory 11 are associated with the times t1 and t2 at which the LiDAR has passed through the coordinates P1 and P2, respectively. In addition, each of the point cloud data G1 and G2 acquired with each of the coordinates P1 and P2 constituting the trajectory 11 as a base point is associated with each of the times t1 and t2 at which the LiDAR has passed through each of the coordinates P1 and P2.

Each time at which the LiDAR has passed through each point cloud data acquired by the LiDAR and each coordinate serving as a base point of each point cloud data is referred to as point cloud data information. That is, the point cloud data information includes each point cloud data acquired with each coordinate as a base point, and each time at which the LiDAR has passed through each coordinate as a base point when each point cloud data is acquired.

The LiDAR outputs the acquired point cloud data information to the information processing device 50. The LiDAR may output the point cloud data information to the information processing device 50 via a wireless or wired communication line, or may output the point cloud data information to the information processing device 50 via a storage medium.

### <Image Data Acquisition Device>

The image data acquisition device 30 acquires image data. The image data acquisition device 30 is, for example, a camera. Note that the image data acquisition device 30 is not limited to a camera as long as it is a device that acquires image data, and may be a device that acquires image data that a person skilled in the art would conceive. Hereinafter, a camera will be described as an example of the image data acquisition device 30.

The image data is preferably a still image. For example, in a case where long-time inspection of the facility 60 is assumed, such as a water conduit, the moving image requires a large-capacity battery and a storage device. Therefore, it is difficult to inspect the facility 60 due to the weight and size of the equipment. However, it is not excluded that the image data includes a fragmentary moving image of, for example, about several seconds as long as the inspection of the facility 60 is not difficult. Hereinafter, a still image will be described as an example of image data.

The camera is moved by the moving object 41. The moving object 41 is, for example, a person such as a worker. Note that the moving object 41 is not limited to a person such as a worker, and may be a device similar to the moving object 40 and may be separate from the moving object 40. In addition, it is not excluded that the moving object 41 and the moving object 40 move integrally.

The camera moves through the facility 60 with the IMU and LiDAR. The camera photographs a deterioration event of the facility 60 based on visual observation by the worker, past inspection information, and the like. The deterioration event includes, for example, cracking of the wall surface, peeling of the wall surface, water leakage from the wall surface, and the like. Note that the deterioration event is not limited to deterioration of the wall surface, and may be deterioration of a facility that a person skilled in the art would conceive. The camera may acquire a direction from a coordinate serving as a base point when the deterioration event is captured to the deterioration event.

The camera has a timer. The timer is linked to the start of point cloud data acquisition by LiDAR. The camera acquires the time of the timer at the time of image data acquisition. As a result, the image data is associated with the time at which the camera has captured the image data.

For example, as illustrated in FIG. 1, the coordinates P1 and P2 will be described as an example. The coordinates P1 and P2 constituting the trajectory 11 are associated with the times t1 and t2 at which the LiDAR has passed through the coordinates P1 and P2, respectively. The camera captures the image data H1 at time t1. Then, the image data H1 is associated with the time t1. As a result, the image data H1 is associated with the coordinates P1 on the trajectory 11 associated with the time t1 by the information processing device 50 to be described later.

The image data acquired by the camera and the time when the image data is captured are referred to as image data information. That is, the image data information includes the image data obtained by photographing the facility 60 and the time when the image data is captured.

The camera outputs the acquired image data information to the information processing device 50. The camera may output the image data information to the information processing device 50 via a wireless or wired communication line, or may output the image data information to the information processing device 50 via a storage medium.

### <Moving Object>

The moving objects 40 and 41 move through the facility 60. The moving objects 40 and 41 are, for example, mobile robots, drones, vehicles, workers, and the like. Note that the moving objects 40 and 41 are not limited to these as long as they are equipped with the IMU, the LiDAR, and the camera and can move through the facility 60, and may be those that a person skilled in the art would conceive. The moving object 40 may be equipped with an IMU and a LiDAR, and the moving object 41 may be equipped with a camera. The moving object 41 is, for example, a worker. Note that it is not excluded that the moving objects 40 and 41 integrally move the IMU, the LiDAR, and the camera.

### <Information Processing Device>

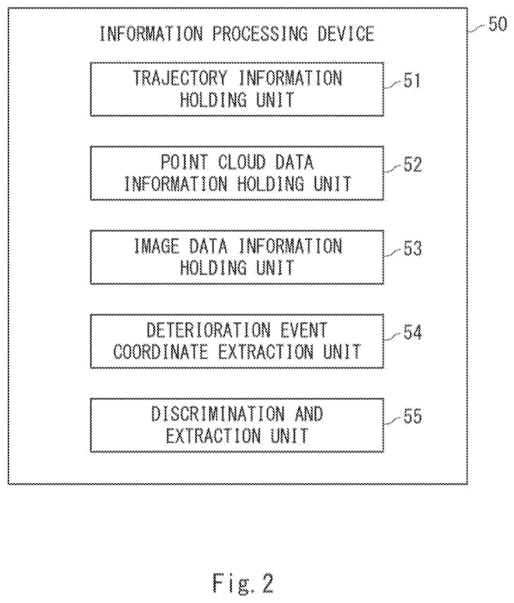

FIG. 2 is a block diagram illustrating the information processing device according to the first example embodiment. As illustrated in FIG. 2, the information processing device 50 includes a trajectory information holding unit 51, a point cloud data information holding unit 52, an image data information holding unit 53, a deterioration event coordinate extraction unit 54, and a discrimination and extraction unit 55. The trajectory information holding unit 51, the point cloud data information holding unit 52, the image data information holding unit 53, the deterioration event coordinate extraction unit 54, and the discrimination and extraction unit 55 have functions as a trajectory information holding means, a point cloud data information holding means, an image data information holding means, a deterioration event coordinate extraction means, and a discrimination and extraction means, respectively.

The information processing device 50 may be configured by hardware including a microcomputer including, for example, a central processing unit (CPU), a read only memory (ROM), a random access memory (RAM), an interface unit (I/F), and the like. The CPU performs a holding process, an extraction process, a control process, and the like. The ROM stores a holding program executed by the CPU, an extraction program, a control program, and the like. The RAM stores various data such as trajectory information, point cloud data information, and image data information. The interface unit (I/F) inputs and outputs signals to and from the outside. The interface unit may include an input device such as a keyboard, a touch panel, or a mouse, or may include an output device such as a display or a speaker. The interface unit accepts data input operation by the user and outputs information to the user. The CPU, ROM, RAM, and interface unit are connected to each other via a data bus or other means.

The trajectory information holding unit 51 holds the trajectory information output from the IMU. The trajectory information includes a trajectory 11 of coordinates as a base point when the LiDAR is moved in the facility 60 to acquire point cloud data of the facility 60 using the LiDAR, each coordinate of a plurality of base points constituting the trajectory 11, and each time at which the LiDAR has passed through each coordinate. The trajectory information holding unit 51 may hold each coordinate constituting the trajectory 11 in association with each time at which the LiDAR has passed through each coordinate.

The point cloud data information holding unit 52 holds the point cloud data information output from the LiDAR. The point cloud data information includes each point cloud data acquired with each coordinate constituting the trajectory 11 as a base point, and each time at which the LiDAR has passed through each coordinate serving as a base point when each point cloud data is acquired. The point cloud data information holding unit 52 may hold each point cloud data acquired with each coordinate constituting the trajectory 11 as a base point in association with each time at which the LiDAR has passed through each coordinate.

The image data information holding unit 53 holds the image data information output from the camera. The image data information includes image data obtained by photographing the facility 60 and time when the image data is acquired. The image data information holding unit 53 may hold the image data in association with coordinates on the trajectory 11 associated with the same time as the capturing time.

The deterioration event coordinate extraction unit 54 analyzes the deterioration event of the facility 60 from the trajectory information and the point cloud data information. The deterioration event coordinate extraction unit 54 may analyze a deterioration event using a past inspection result. For example, the deterioration event coordinate extraction unit 54 may compare the past point cloud data of the facility 60 with the current point cloud data and analyze the deterioration event from the changed portion. In addition, the deterioration event coordinate extraction unit 54 may compare the design data of the facility 60 with the current point cloud data and analyze the deterioration event from the changed portion.

Then, the deterioration event coordinate extraction unit 54 extracts deterioration event coordinates which become a base point when the point cloud data including the deterioration event of the facility 60 is acquired from the trajectory information and the point cloud data information. The deterioration event coordinate extraction unit 54 may cause the trajectory information holding unit 51 to hold the extracted deterioration event coordinates.

The discrimination and extraction unit 55 discriminates and extracts deterioration event coordinates according to the presence of image data associated with the extracted deterioration event coordinates. Specifically, the discrimination and extraction unit 55 determines whether image data is associated with each deterioration event coordinate. Then, deterioration event coordinates associated with the image data and deterioration event coordinates not associated with the image data are discriminated and extracted.

The information processing device 50 outputs the acquired trajectory information, point cloud data information, image data information, and deterioration event coordinates to the facility inspection display device 100. The information processing device 50 may output these pieces of information to the facility inspection display device 100 via a wireless or wired communication line, or may output these pieces of information to the facility inspection display device 100 via a storage medium.

### <Facility Inspection Display Device>

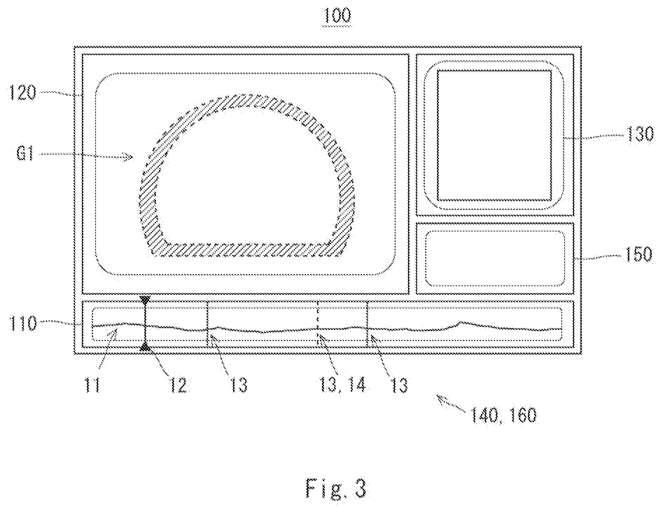

FIG. 3 is a plan view illustrating a display screen of the facility inspection display device according to the first example embodiment. As illustrated in FIG. 3, the facility inspection display device 100 includes a trajectory display unit 110, a point cloud data display unit 120, an image data display unit 130, a deterioration event display unit 140, a coordinate display unit 150, and a discrimination display unit 160. The trajectory display unit 110, the point cloud data display unit 120, the image data display unit 130, the deterioration event display unit 140, the coordinate display unit 150, and the discrimination display unit 160 have functions as a trajectory display means, a point cloud data display means, an image data display means, a deterioration event display means, a coordinate display means, and a discrimination display means, respectively.

The facility inspection display device 100 is a user interface, and may be configured by hardware including a microcomputer including, for example, a central processing unit (CPU), a read only memory (ROM), a random access memory (RAM), an interface unit (I/F), and the like. The CPU performs display processing, control processing, and the like. The ROM stores a display program executed by the CPU, a control program, and the like. The RAM stores various data such as trajectory information, point cloud data information, and image data information. The interface unit (I/F) inputs and outputs signals to and from the outside. The interface unit may include an input device such as a keyboard, a touch panel, or a mouse, or may include an output device such as a display or a speaker. The interface unit accepts data input operation by the user and outputs information to the user. The CPU, ROM, RAM, and interface unit are connected to each other via a data bus or other means.

The trajectory display unit 110 displays a trajectory 11 of coordinates as a base point when point cloud data of the facility 60 using LiDAR is acquired by moving LiDAR in the facility 60. The trajectory display unit 110 displays, for example, the trajectory 11 viewed from one direction using a line. For example, the trajectory display unit 110 may display the trajectory 11 viewed from the side surface of the water conduit using a line, or may display the trajectory 11 viewed from above the water conduit using a line. Each coordinate constituting the trajectory 11 is associated with each time at which the LiDAR has passed through each coordinate.

The point cloud data display unit 120 displays the point cloud data G1 acquired with the user-designated coordinate at the user-designated position 12 on the trajectory 11 designated by the user in the trajectory display unit 110 as the base point. In the trajectory display unit 110, the position may be indicated as, for example, a vertical line intersecting the coordinates on the trajectory 11. Specifically, for example, the user-designated position 12 may be indicated as a vertical line intersecting the user-designated coordinates on the trajectory 11 in the trajectory display unit 110. For the user-designated position 12, for example, coordinates on the trajectory 11 may be selected by the user on the trajectory display unit 110 using a touch panel function, or coordinates on the trajectory 11 may be selected using a mouse pointer function. Each point cloud data acquired with each coordinate constituting the trajectory 11 as a base point is associated with each time at which the LiDAR has passed through each coordinate.

The image data display unit 130 displays image data obtained by photographing the facility 60. The image data is associated with coordinates on the trajectory 11 associated with the same time as the acquired time. When the user designates the user-designated position 12 and there is image data associated with the user-designated coordinates at the user-designated position 12, the image data display unit 130 displays the image data associated with the user-designated coordinates.

The deterioration event display unit 140 causes the trajectory display unit 110 to display, as the deterioration event position 13, the deterioration event coordinates serving as the base point when the point cloud data including the deterioration event of the facility 60 is acquired. Specifically, the deterioration event position 13 may be indicated as a vertical line intersecting the deterioration event coordinates on the trajectory 11 in the trajectory display unit 110.

The coordinate display unit 150 displays coordinates as a base point when the point cloud data is acquired. For example, the coordinate display unit 150 displays deterioration event coordinates. When the user designates the deterioration event position 13 as the user-designated position 12, the coordinate display unit 150 displays the deterioration event coordinates. When the image data is associated with the deterioration event coordinates of the user-designated position 12, the image data display unit 130 displays the image data associated with the deterioration event coordinates. Therefore, the coordinates displayed by the coordinate display unit 150 can also be referred to as coordinates serving as a base point when the image data is acquired.

The coordinate display unit 150 may display at least one of the direction from the deterioration event coordinates to the deterioration event and the time at which the LiDAR has passed through the deterioration event coordinates.

The discrimination display unit 160 discriminates and displays the deterioration event position 13 depending on the presence of image data associated with the deterioration event coordinates. Specifically, for example, the discrimination display unit 160 indicates the deterioration event position 13 including the deterioration event coordinates associated with the image data by a solid line, and indicates the deterioration event position 14 including the deterioration event coordinates not associated with the image data by a dotted line. As a result, the discrimination display unit 160 discriminates and displays the deterioration event positions 13 and 14.

### <Facility Inspection Method>

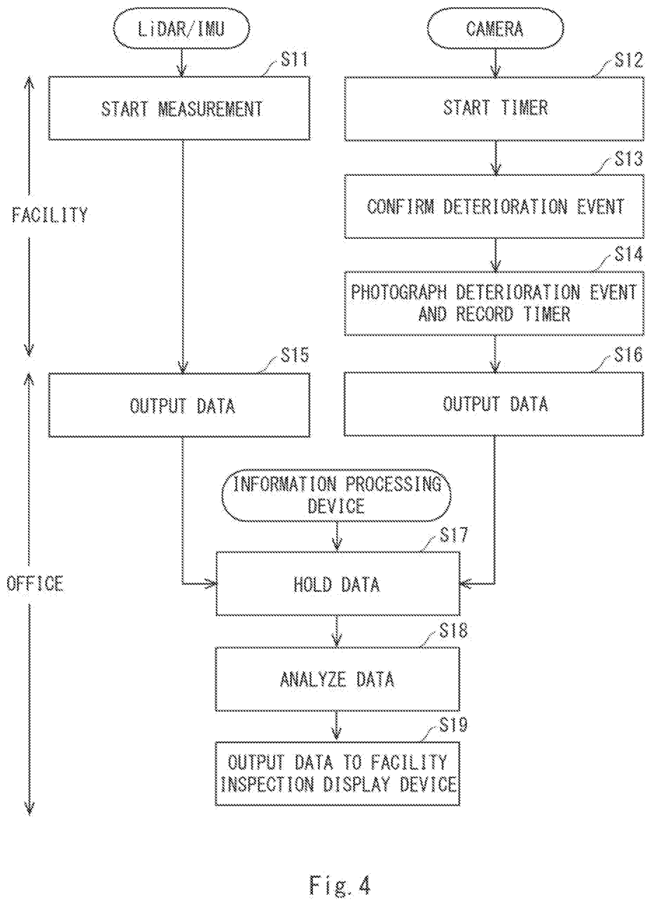

Next, a facility inspection method of the present example embodiment will be described. FIG. 4 is a flowchart illustrating a facility inspection method according to the first example embodiment. As illustrated in FIG. 4, steps S11 to S14 are operations in the facility 60 such as a water conduit, for example. Steps S15 to S19 are operations in an office or the like in which the information processing device 50 and the facility inspection display device 100 are arranged.

As shown in step S11, measurement by LiDAR and IMU is started in the facility 60. As a result, the inspection of the facility 60 is performed using the LiDAR and the IMU, and the point cloud data and the trajectory data of the facility 60 are acquired.

On the other hand, as shown in step S12, in the facility 60, the timer of the camera is started in synchronization with the start of measurement by the LiDAR and the IMU.

Next, as shown in step S13, a deterioration event of the facility 60 is confirmed. Specifically, the position of the deterioration event of the facility 60 is confirmed based on the worker's visual observation or past inspection results.

Next, as shown in step S14, the deterioration event of the facility 60 is captured, and a timer at the time of photographing is recorded. Specifically, the worker or the moving object 41 photographs a deterioration event of the facility 60 with a camera to acquire image data. Then, time information of the timer is recorded at the time of image data acquisition. In this way, the point cloud data information, the trajectory information, and the image data information of the facility 60 are acquired.

Next, as shown in steps S15 and S16, data is output. Specifically, after completion of the inspection of the facility 60, the point cloud data and the trajectory data acquired by the LiDAR and the IMU are output to the information processing device 50. In addition, image data acquired by the camera is output to the information processing device 50.

Next, as shown in step S17, data is held. Specifically, in the information processing device 50, the trajectory information holding unit 51 holds the trajectory information output from the IMU. The trajectory information holding unit 51 may hold each coordinate constituting the trajectory 11 in association with each time at which the LiDAR has passed through each coordinate. The point cloud data information holding unit 52 holds the point cloud data information output from the LiDAR. The point cloud data information holding unit 52 may hold each point cloud data acquired with each coordinate constituting the trajectory 11 as a base point in association with each time at which the LiDAR has passed through each coordinate. The image data information holding unit 53 holds the image data information output from the camera. The image data information holding unit 53 may hold the image data in association with coordinates on the trajectory 11 associated with the same time as the capturing time.

Next, as shown in step S18, data is analyzed. Specifically, in the information processing device 50, the deterioration event coordinate extraction unit 54 analyzes the deterioration event of the facility 60 from the trajectory information and the point cloud data information. Then, the deterioration event coordinate extraction unit 54 extracts deterioration event coordinates which become a base point when the point cloud data including the deterioration event of the facility 60 is acquired from the trajectory information and the point cloud data information. The deterioration event coordinate extraction unit 54 may cause the trajectory information holding unit 51 to hold the extracted deterioration event coordinates.

In addition, the discrimination and extraction unit 55 discriminates and extracts deterioration event coordinates according to the presence of image data associated with the extracted deterioration event coordinates. Specifically, the discrimination and extraction unit 55 determines whether image data is associated with each deterioration event coordinate. Then, deterioration event coordinates associated with the image data and deterioration event coordinates not associated with the image data are discriminated and extracted.

Next, as described in step S19, the held data and the analyzed data are output to the facility inspection display device 100. Specifically, the information processing device 50 outputs the trajectory information, the point cloud data information, the image data information, the deterioration event coordinates, and the like to the facility inspection display device 100.

### <Facility Inspection Display Method>

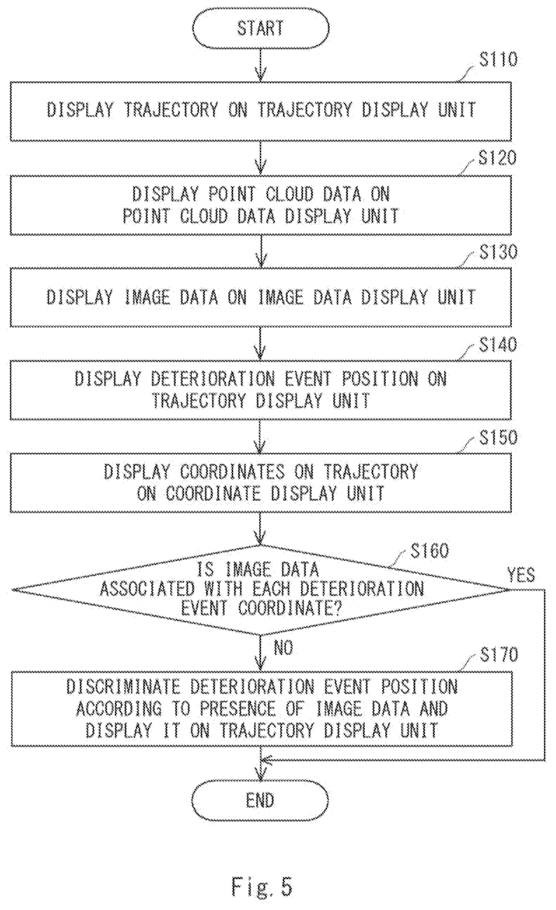

Next, a facility inspection display method using the facility inspection display device 100 will be described. FIG. 5 is a flowchart illustrating the facility inspection display method according to the first example embodiment. As illustrated in step S110 in FIG. 5, the trajectory 11 is displayed on the trajectory display unit 110. Specifically, the trajectory display unit 110 displays a trajectory 11 of coordinates as a base point when the LiDAR is moved in the facility 60 to acquire the point cloud data of the facility 60 using the LiDAR.

Next, as shown in step S120, the point cloud data is displayed on the point cloud data display unit 120. Specifically, the point cloud data acquired with the user-designated coordinate at the user-designated position 12 on the trajectory 11 designated by the user in the trajectory display unit 110 as the base point is displayed on the point cloud data display unit 120.

Next, as shown in step S130, the image data is displayed on the image data display unit 130. Specifically, image data obtained by photographing the facility 60 is displayed on the image data display unit 130. At this time, each coordinate constituting the trajectory 11 is associated with each time at which the LiDAR has passed through each coordinate. In addition, each point cloud data acquired with each coordinate constituting the trajectory 11 as a base point is associated with each time at which the LiDAR has passed through each coordinate. Then, the image data is associated with coordinates on the trajectory 11 associated with the same time as the acquired time. Therefore, when there is image data associated with the user-designated coordinates, the image data display unit 130 is caused to display the image data.

Next, as shown in step S140, the deterioration event position 13 is displayed on the trajectory display unit 110. Specifically, the deterioration event coordinates as a base point when the point cloud data including the deterioration event of the facility 60 is acquired are displayed on the trajectory display unit 110 as the deterioration event position.

Next, as shown in step S150, the coordinates on the trajectory 11 are displayed on the coordinate display unit 150. Specifically, a coordinate serving as a base point when the point cloud data is acquired is displayed on the coordinate display unit 150. For example, deterioration event coordinates serving as base points when point cloud data including deterioration events of the facility 60 is acquired may be displayed on the coordinate display unit 150. When the deterioration event coordinates are displayed, at least one of the direction from the deterioration event coordinates to the deterioration event and the time at which the LiDAR has passed through the deterioration event coordinates may be displayed on the coordinate display unit 150.

Next, as shown in step S160, it is determined whether image data is associated with each deterioration event coordinate. In step S160, in a case of YES in which the image data is associated with each deterioration event coordinate, the process ends. On the other hand, in a case of NO in which the image data is not associated with each deterioration event coordinate in step S160, as shown in step S170, the deterioration event positions 13 and 14 are discriminated depending on the presence of the image data and displayed on the trajectory display unit 110. Specifically, the discrimination display unit 160 indicates the deterioration event position 13 by a solid vertical line when there is image data associated with the deterioration event coordinates, and indicates the deterioration event position 14 by a dotted vertical line when there is no image data associated with the deterioration event coordinates. In this manner, the discrimination display unit 160 discriminates the deterioration event positions 13 and 14 depending on the presence of the image data. Then, the processing ends.

Next, effects of the present example embodiment will be described. In the present example embodiment, the LiDAR is moved together with the IMU in the facility 60, thereby acquiring the trajectory of the coordinates as the base point when the point cloud data of the facility 60 is acquired. Therefore, the coordinates and time can be associated with the point cloud data, and the accuracy of the position in the point cloud data of the facility 60 can be improved.

In addition, image data of the facility 60 is acquired using a timer synchronized with detection of the LiDAR and the IMU. Therefore, the image data can be associated with time and coordinates, and the accuracy of the position in the image data of the facility 60 can be improved. As described above, in the present example embodiment, the trajectory data acquired by the IMU is used for synchronization of the point cloud data and the image data. Therefore, the point cloud data and the image data can be associated with each other, and the deterioration event coordinates and the image data can be associated with each other.

Further, in the present example embodiment, the deterioration event coordinates as a base point when the point cloud data including the deterioration event of the facility 60 is acquired are displayed on the trajectory display unit 110 as the deterioration event positions. The deterioration event coordinates may be displayed on the coordinate display unit 150. In addition, the coordinate display unit 150 may display at least one of the direction from the deterioration event coordinates to the deterioration event and the time at which the LiDAR has passed through the deterioration event coordinates. This makes it possible to improve the visibility in the display of the position of the deterioration event.

In the present example embodiment, the deterioration event positions 13 and 14 are displayed on the trajectory display unit 110 in a discriminated manner depending on the presence of image data associated with the deterioration event coordinates. Therefore, deterioration event coordinates having no corresponding image data can be displayed.

### Second Example Embodiment

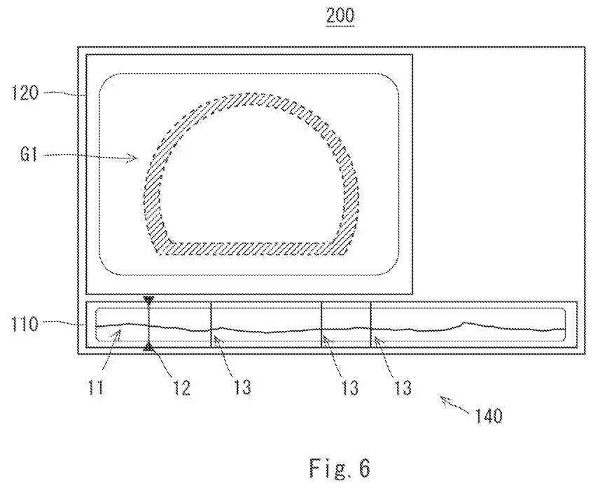

Next, a facility inspection display device and an information processing device according to a second example embodiment will be described. In the present example embodiment, main features of the facility inspection display device and the information processing device are extracted. FIG. 6 is a plan view illustrating a display screen of the facility inspection display device according to the second example embodiment. As illustrated in FIG. 6, the facility inspection display device 200 includes a trajectory display unit 110, a point cloud data display unit 120, and a deterioration event display unit 140.

The trajectory display unit 110 displays a trajectory of coordinates as a base point when point cloud data of the facility 60 using LiDAR is acquired by moving LiDAR in the facility 60. The point cloud data display unit 120 displays the point cloud data G1 acquired with the user-designated coordinate at the user-designated position 12 on the trajectory 11 designated by the user in the trajectory display unit 110 as the base point. The deterioration event display unit 140 causes the trajectory display unit 110 to display, as the deterioration event position 13, the deterioration event coordinates serving as the base point when the point cloud data including the deterioration event of the facility 60 is acquired.

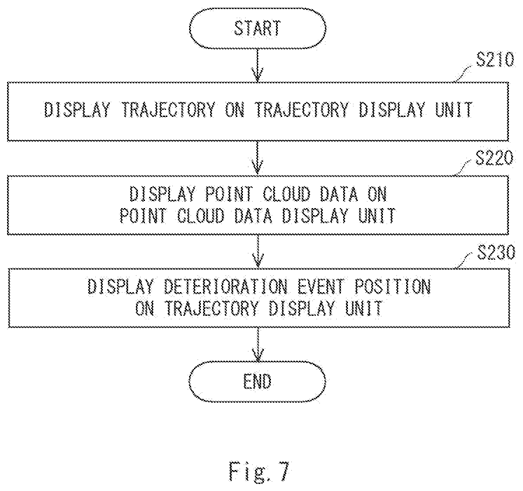

FIG. 7 is a flowchart illustrating a facility inspection display method according to the second example embodiment. As illustrated in step S210 of FIG. 7, the trajectory 11 is displayed on the trajectory display unit 110. Specifically, the trajectory display unit 110 displays a trajectory 11 of coordinates as a base point when the LiDAR is moved in the facility 60 to acquire the point cloud data of the facility 60 using the LiDAR.

Next, as shown in step S220, the point cloud data is displayed on the point cloud data display unit 120. Specifically, the point cloud data acquired with the user-designated coordinate at the user-designated position 12 on the trajectory 11 designated by the user in the trajectory display unit 110 as the base point is displayed on the point cloud data display unit 120.

Next, as shown in step S230, the deterioration event position 13 is displayed on the trajectory display unit 110. Specifically, the deterioration event coordinates as a base point when the point cloud data including the deterioration event of the facility 60 is acquired are displayed on the trajectory display unit 110 as the deterioration event position.

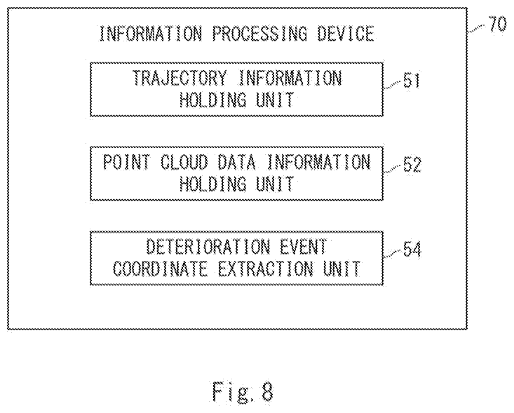

FIG. 8 is a block diagram illustrating an information processing device according to a second example embodiment. As illustrated in FIG. 8, the information processing device 70 includes a trajectory information holding unit 51, a point cloud data information holding unit 52, and a deterioration event coordinate extraction unit 54.

The trajectory information holding unit 51 holds trajectory information including a trajectory 11 of coordinates as a base point when point cloud data of the facility 60 using LiDAR is acquired by moving the LiDAR in the facility 60, each coordinate of a plurality of base points constituting the trajectory 11, and each time at which the LiDAR has passed through each coordinate.

The point cloud data information holding unit 52 holds point cloud data information including each point cloud data acquired with each coordinate as a base point and each time at which the LiDAR has passed through each coordinate as a base point when each point cloud data is acquired.

The deterioration event coordinate extraction unit 54 extracts deterioration event coordinates which become a base point when the point cloud data including the deterioration event of the facility 60 is acquired from the trajectory information and the point cloud data information.

According to the present example embodiment, it is possible to improve the visibility in the display of the deterioration event position. Other configurations and effects of the second example embodiment are included in the description of the first example embodiment.

Although the present invention has been described above with reference to the first and second example embodiments, the present invention is not limited to the above first and second example embodiments. Various modifications that can be understood by those skilled in the art can be made to the configuration and details of the present invention within the scope of the present invention. For example, an example embodiment combining the respective configurations of the first and second example embodiments is also included in the scope of the technical concept. A facility inspection display program for causing a computer to execute the facility inspection display methods of the first and second example embodiments is also included in the technical scope of the first and second example embodiments.

Some or all of the above-described example embodiments can be described as in the following supplementary notes, but are not limited to the following supplementary notes.

### (Supplementary Note 1)

A facility inspection display device including:
a trajectory display means for displaying a trajectory of coordinates serving as a base point when point cloud data of a facility using LiDAR is acquired by moving the LiDAR in the facility;
a point cloud data display means for displaying the point cloud data acquired with user-designated coordinates at a user-designated position on the trajectory designated by a user in the trajectory display means as the base point; and
a deterioration event display means for causing the trajectory display means to display, as a deterioration event position, deterioration event coordinates serving as the base point when the point cloud data including a deterioration event of the facility is acquired.

### (Supplementary Note 2)

The facility inspection display device according to supplementary note 1, further including a coordinate display means for displaying the coordinates serving as the base point when the point cloud data is acquired,
in which the coordinate display means displays the deterioration event coordinates.

### (Supplementary Note 3)

The facility inspection display device according to supplementary note 2, in which the coordinate display means displays at least one of a direction from the deterioration event coordinates to the deterioration event and a time at which the LiDAR has passed through the deterioration event coordinates.

### (Supplementary Note 4)

The facility inspection display device according to any one of supplementary notes 1 to 3, further including an image data display means for displaying image data obtained by photographing the facility, in which
each coordinate constituting the trajectory is associated with each time at which the LiDAR has passed through each coordinate,
each point cloud data acquired with each of the coordinates constituting the trajectory as the base point is associated with each time at which the LiDAR has passed through each of the coordinates,
the image data is associated with the coordinates on the trajectory associated with the same time as the acquired time, and
in a case where there is the image data associated with the user-designated coordinates, the image data display means displays the image data.

### (Supplementary Note 5)

The facility inspection display device according to supplementary note 4, further including a discrimination display means for discriminating the deterioration event position according to the presence of the image data associated with the deterioration event coordinates and causing the trajectory display means to display the deterioration event position.

### (Supplementary Note 6)

An information processing device including:
a trajectory information holding means for holding trajectory information including a trajectory of coordinates serving as a base point when point cloud data of a facility using LiDAR is acquired by moving the LiDAR in the facility, each coordinate of a plurality of base points constituting the trajectory, and each time at which the LiDAR has passed through each coordinate;
a point cloud data information holding means for holding point cloud data information including each point cloud data acquired with each coordinate as the base point and each time at which the LiDAR has passed through each coordinate serving as the base point when each point cloud data is acquired; and
a deterioration event coordinate extraction means for extracting deterioration event coordinates serving as the base point when the point cloud data including a deterioration event of the facility is acquired from the trajectory information and the point cloud data information.

### (Supplementary Note 7)

The information processing device according to supplementary note 6, further including an image data information holding means for holding image data obtained by photographing the facility and image data information including a time at which the image data is acquired, in which
the trajectory information holding means holds each of the coordinates constituting the trajectory in association with each time at which the LiDAR has passed through each of the coordinates,
the point cloud data information holding means holds each point cloud data acquired with each of the coordinates constituting the trajectory as the base point in association with each time at which the LiDAR has passed through each of the coordinates, and
the image data information holding means holds the image data in association with the coordinates on a trajectory associated with the same time as the acquired time.

### (Supplementary Note 8)

The information processing device according to supplementary note 7, further including a discrimination and extraction means for discriminating and extracting the deterioration event coordinates according to the presence of the image data associated with the extracted deterioration event coordinates.

### (Supplementary Note 9)

A facility inspection display method including:
a step of causing a trajectory display means to display a trajectory of coordinates serving as a base point when point cloud data of a facility using LiDAR is acquired by moving the LiDAR in the facility;
a step of causing a point cloud data display means to display the point cloud data acquired with user-designated coordinates at a user-designated position on the trajectory designated by a user in the trajectory display means as the base point; and
a step of causing the trajectory display means to display, as a deterioration event position, deterioration event coordinates serving as the base point when the point cloud data including the deterioration event of the facility is acquired.

### (Supplementary Note 10)

The facility inspection display method according to supplementary note 9, further including a step of causing a coordinate display means to display the coordinates serving as the base point when the point cloud data is acquired,
in which the step of causing the coordinate display means to display involves causing the coordinate display means to display the deterioration event coordinates.

### (Supplementary Note 11)

The facility inspection display method according to supplementary note 10, in which the step of causing the coordinate display means to display involves causing the coordinate display means to display at least one of a direction from the deterioration event coordinates to the deterioration event and a time at which the LiDAR has passed through the deterioration event coordinates.

### (Supplementary Note 12)

The facility inspection display method according to any one of supplementary notes 9 to 11, further including a step of causing an image data display means to display image data obtained by photographing the facility, in which
in the step of causing the image data display means to display the image data,
each coordinate constituting the trajectory is associated with each time at which the LiDAR has passed through each coordinate,
each point cloud data acquired with each of the coordinates constituting the trajectory as the base point is associated with each time at which the LiDAR has passed through each of the coordinates,
the image data is associated with the coordinates on the trajectory associated with the same time as the acquired time, and
the image data display means is caused to display the image data in a case where there is the image data associated with the user-designated coordinates.

### (Supplementary Note 13)

The facility inspection display method according to supplementary note 12, further including a step of discriminating the deterioration event position according to the presence of the image data associated with the deterioration event coordinates and causing the trajectory display means to display the deterioration event position.

### (Supplementary Note 14)

A non-transitory computer-readable medium storing a facility inspection display program for causing a computer to execute:
a step of causing a trajectory display means to display a trajectory of coordinates serving as a base point when point cloud data of a facility using LiDAR is acquired by moving the LiDAR in the facility;
a step of causing a point cloud data display means to display the point cloud data acquired with user-designated coordinates at a user-designated position on the trajectory designated by a user in the trajectory display means as the base point; and
a step of causing the trajectory display means to display, as a deterioration event position, deterioration event coordinates serving as the base point when the point cloud data including the deterioration event of the facility is acquired.

### (Supplementary Note 15)

The non-transitory computer-readable medium storing the facility inspection display program according to supplementary note 14, the program causing the computer to further execute a step of causing a coordinate display means to display the coordinates serving as the base point when the point cloud data is acquired,
in which the step of causing the coordinate display means to display involves causing the coordinate display means to display the deterioration event coordinates.

### (Supplementary Note 16)

The non-transitory computer-readable medium storing the facility inspection display program according to supplementary note 15, in which the step of causing the coordinate display means to display involves causing the coordinate display means to display at least one of a direction from the deterioration event coordinates to the deterioration event and a time at which the LiDAR has passed through the deterioration event coordinates.

### (Supplementary Note 17)

The non-transitory computer-readable medium storing the facility inspection display program according to any one of supplementary notes 14 to 16, the program causing the computer to further execute a step of causing an image data display means to display image data obtained by photographing the facility, in which
in the step of causing the image data display means to display the image data,
each coordinate constituting the trajectory is associated with each time at which the LiDAR has passed through each coordinate,
each point cloud data acquired with each of the coordinates constituting the trajectory as the base point is associated with each time at which the LiDAR has passed through each of the coordinates,
the image data is associated with the coordinates on the trajectory associated with the same time as the acquired time, and
the image data display means is caused to display the image data in a case where there is the image data associated with the user-designated coordinates.

### (Supplementary Note 18)

The non-transitory computer-readable medium storing the facility inspection display program according to supplementary note 17, the program causing the computer to further execute a step of discriminating the deterioration event position according to the presence of the image data associated with the deterioration event coordinates and causing the trajectory display means to display the deterioration event position.

In the above-described example, the program may be stored using various types of non-transitory computer-readable media and supplied to a computer. The non-transitory computer-readable media include various types of tangible storage media. Examples of the non-transitory computer-readable medium include a magnetic recording medium (for example, a flexible disk, a magnetic tape, or a hard disk drive), an optical magnetic recording medium (for example, a magneto-optical disk), a compact disc-read only memory (CD-ROM), a CD-R, a CD-R/W, and a semiconductor memory (for example, a mask ROM, a programmable ROM (PROM), an erasable PROM (EPROM), a flash ROM, or a random access memory (RAM). The program may be supplied to the computer by various types of transitory computer-readable media. Examples of transitory computer-readable media include electrical signals, optical signals, and electromagnetic waves. The transitory computer-readable media can supply programs to computers via wired or wireless communication paths, such as wires and optical fiber.

### REFERENCE SIGNS LIST

1 FACILITY INSPECTION SYSTEM
10 INERTIAL MOTION DETECTION DEVICE
11 TRAJECTORY
12 USER-DESIGNATED POSITION
13, 14 DETERIORATION EVENT POSITION
20 POINT CLOUD DATA ACQUISITION DEVICE
30 IMAGE DATA ACQUISITION DEVICE
40, 41 MOVING OBJECT
50 INFORMATION PROCESSING DEVICE
51 TRAJECTORY INFORMATION HOLDING UNIT
52 POINT CLOUD DATA INFORMATION HOLDING UNIT
53 IMAGE DATA INFORMATION HOLDING UNIT
54 DETERIORATION EVENT COORDINATE EXTRACTION UNIT
55 DISCRIMINATION AND EXTRACTION UNIT
60 FACILITY
70 INFORMATION PROCESSING DEVICE
100, 200 FACILITY INSPECTION DISPLAY DEVICE
110 TRAJECTORY DISPLAY UNIT
120 POINT CLOUD DATA DISPLAY UNIT
130 IMAGE DATA DISPLAY UNIT
140 DETERIORATION EVENT DISPLAY UNIT
150 COORDINATE DISPLAY UNIT
160 DISCRIMINATION DISPLAY UNIT

What is claimed is:

1. A facility inspection display device comprising:
a trajectory display unit configured to display a trajectory of coordinates serving as a base point when point cloud data of a facility using LiDAR is acquired by moving the LiDAR in the facility;
a point cloud data display unit configured to display the point cloud data acquired with user-designated coordinates at a user-designated position on the trajectory designated by a user in the trajectory display means as the base point; and
a deterioration event display unit configured to cause the trajectory display unit to display, as a deterioration event position, deterioration event coordinates serving as the base point when the point cloud data including a deterioration event of the facility is acquired.

2. The facility inspection display device according to claim 1, further comprising a coordinate display unit configured to display the coordinates serving as the base point when the point cloud data is acquired,
wherein the coordinate display unit displays the deterioration event coordinates.

3. The facility inspection display device according to claim 2, wherein the coordinate display unit displays at least one of a direction from the deterioration event coordinates to the deterioration event and a time at which the LiDAR has passed through the deterioration event coordinates.

4. The facility inspection display device according to claim 1, further comprising an image data display unit configured to display image data obtained by photographing the facility, wherein
each coordinate constituting the trajectory is associated with each time at which the LiDAR has passed through each coordinate,
each point cloud data acquired with each of the coordinates constituting the trajectory as the base point is associated with each time at which the LiDAR has passed through each of the coordinates,
the image data is associated with the coordinates on the trajectory associated with the same time as the acquired time, and
in a case where there is the image data associated with the user-designated coordinates, the image data display means displays the image data.

5. The facility inspection display device according to claim 4, further comprising a discrimination display unit configured to discriminate the deterioration event position according to the presence of the image data associated with the deterioration event coordinates and causing the trajectory display unit to display the deterioration event position.

6. An information processing device comprising:
a trajectory information holding unit configured to hold trajectory information including a trajectory of coordinates serving as a base point when point cloud data of a facility using LiDAR is acquired by moving the LiDAR in the facility, each coordinate of a plurality of base points constituting the trajectory, and each time at which the LiDAR has passed through each coordinate;
a point cloud data information holding unit configured to hold point cloud data information including each point cloud data acquired with each coordinate as the base point and each time at which the LiDAR has passed through each coordinate serving as the base point when each point cloud data is acquired; and
a deterioration event coordinate extraction unit configured to extract deterioration event coordinates serving as the base point when the point cloud data including a deterioration event of the facility is acquired from the trajectory information and the point cloud data information.

7. The information processing device according to claim 6, further comprising an image data information holding unit configured to hold image data obtained by photographing the facility and image data information including a time at which the image data is acquired, wherein
the trajectory information holding unit holds each of the coordinates constituting the trajectory in association with each time at which the LiDAR has passed through each of the coordinates,
the point cloud data information holding unit holds each point cloud data acquired with each of the coordinates constituting the trajectory as the base point in association with each time at which the LiDAR has passed through each of the coordinates, and
the image data information holding unit holds the image data in association with the coordinates on a trajectory associated with the same time as the acquired time.

8. The information processing device according to claim 7, further comprising a discrimination and extraction unit configured to discriminate and extract the deterioration event coordinates according to the presence of the image data associated with the extracted deterioration event coordinates.

9-13. (canceled)

14. A non-transitory computer-readable medium storing a facility inspection display program for causing a computer to execute:
a step of causing a trajectory display unit to display a trajectory of coordinates serving as a base point when point cloud data of a facility using LiDAR is acquired by moving the LiDAR in the facility;
a step of causing a point cloud data display unit to display the point cloud data acquired with user-designated coordinates at a user-designated position on the trajectory designated by a user in the trajectory display unit as the base point; and
a step of causing the trajectory display unit to display, as a deterioration event position, deterioration event coordinates serving as the base point when the point cloud data including the deterioration event of the facility is acquired.

15. The non-transitory computer-readable medium storing the facility inspection display program according to claim 14, the program causing the computer to further execute a step of causing a coordinate display unit to display the coordinates serving as the base point when the point cloud data is acquired,
wherein the step of causing the coordinate display means unit to display involves causing the coordinate display unit to display the deterioration event coordinates.

16. The non-transitory computer-readable medium storing the facility inspection display program according to claim 15, wherein the step of causing the coordinate display unit to display involves causing the coordinate display unit to display at least one of a direction from the deterioration event coordinates to the deterioration event and a time at which the LiDAR has passed through the deterioration event coordinates.

17. The non-transitory computer-readable medium storing the facility inspection display program according to claim 14, the program causing the computer to further execute a step of causing an image data display unit to display image data obtained by photographing the facility, wherein
in the step of causing the image data display unit to display the image data,
each coordinate constituting the trajectory is associated with each time at which the LiDAR has passed through each coordinate,
each point cloud data acquired with each of the coordinates constituting the trajectory as the base point is associated with each time at which the LiDAR has passed through each of the coordinates,
the image data is associated with the coordinates on the trajectory associated with the same time as the acquired time, and
the image data display means is caused to display the image data in a case where there is the image data associated with the user-designated coordinates.

18. The non-transitory computer-readable medium storing the facility inspection display program according to claim 17, the program causing the computer to further execute a step of discriminating the deterioration event position according to the presence of the image data associated with the deterioration event coordinates and causing the trajectory display unit to display the deterioration event position.
